(19) United States
(12) Patent Application Publication
(10) Pub. No.: US 2012/0040772 A1
(43) Pub. Date: Feb. 16, 2012

(54) GOLF CLUB HEAD

(76) Inventor: Carlyle Potter, St. George, UT (US)

(21) Appl. No.: 12/853,530

(22) Filed: Aug. 10, 2010

(51) Int. Cl. A63B 53/04; B23P 15/00

(52) U.S. Cl. 473/328; 29/592

(57) ABSTRACT

A golf club includes a face for striking a golf ball and a sole. The face including a leading edge. The sole extends from the face leading edge. The sole includes at least one channel. Each channel includes a first end adjacent to the leading face leading edge, a second end spaced from the first end, a first sidewall and a second sidewall.

### BACKGROUND OF INVENTION

This invention relates to a device for use in playing golf and more particularly to an improved golf club head.

### SUMMARY

A perfect golf swing is one where the face of the golf club makes clean contact with a golf ball wherein the leading edge and sole of the golf club head do not hit the ground prior to striking the ball. Ideally, the face of the club impacts or strikes the ball cleanly and the leading edge and sole enter the ground as contact is made with the ball.

However, for most amateur golfers, striking the ball perfectly on a consistent basis is extremely challenging. Many amateurs often hit slightly behind the ball, causing the leading edge and sole to hit the ground prior to striking the ball. In golf terminology, this is called “hitting a shot fat” or “chunking it”. Without a clean strike on the ball, it is impossible to get maximum distance or maintain control of the shot. Thus, a major difference between pro golfers and amateurs is the pro's ability to always hit the ball cleanly, which allows for maximum distance and control. Therefore, there exists a significant need for an improved golf club head which provides improved distance and control even when the golf club head hits the ground behind the ball prior to striking the ball.

In one embodiment, a golf club head comprises a face for striking a golf ball, the face including a leading edge; and a sole extending from the face leading edge, the sole including a channel, wherein the channel includes a first end adjacent to the leading face leading edge, and a second end spaced from the first end.

In another embodiment, a golf club head comprises a face for striking a golf ball, the face including a leading edge; and a sole extending from the face leading edge, the sole including a plurality of channels, wherein each channel includes a first end adjacent to the leading face leading edge, a second end spaced from the first end, a first sidewall and a second sidewall.

A further embodiment includes, a method for constructing golf club head, comprising: providing a golf club head including a face for striking a golf ball, the face including a leading edge; and a sole extending from the face leading edge; and forming at least one channel in the sole, wherein each channel includes a first end adjacent to the leading face leading edge, a second end spaced from the first end, a first sidewall and a second sidewall.

### BRIEF DESCRIPTION OF THE DRAWINGS

The drawings, when considered in connection with the following description, are presented for the purpose of facilitating an understanding of the subject matter sought to be protected.

FIG. 1 is a schematic, perspective view of an illustrative golf club head;

FIG. 2 is schematic bottom view of an illustrative golf club head;

FIG. 3 is a schematic, front view of an illustrative golf club head;

FIG. 4 is a schematic, rear view of an illustrative golf club head; and

FIG. 5 is a schematic, bottom view of an alternative golf club head.

### DETAILED DESCRIPTION

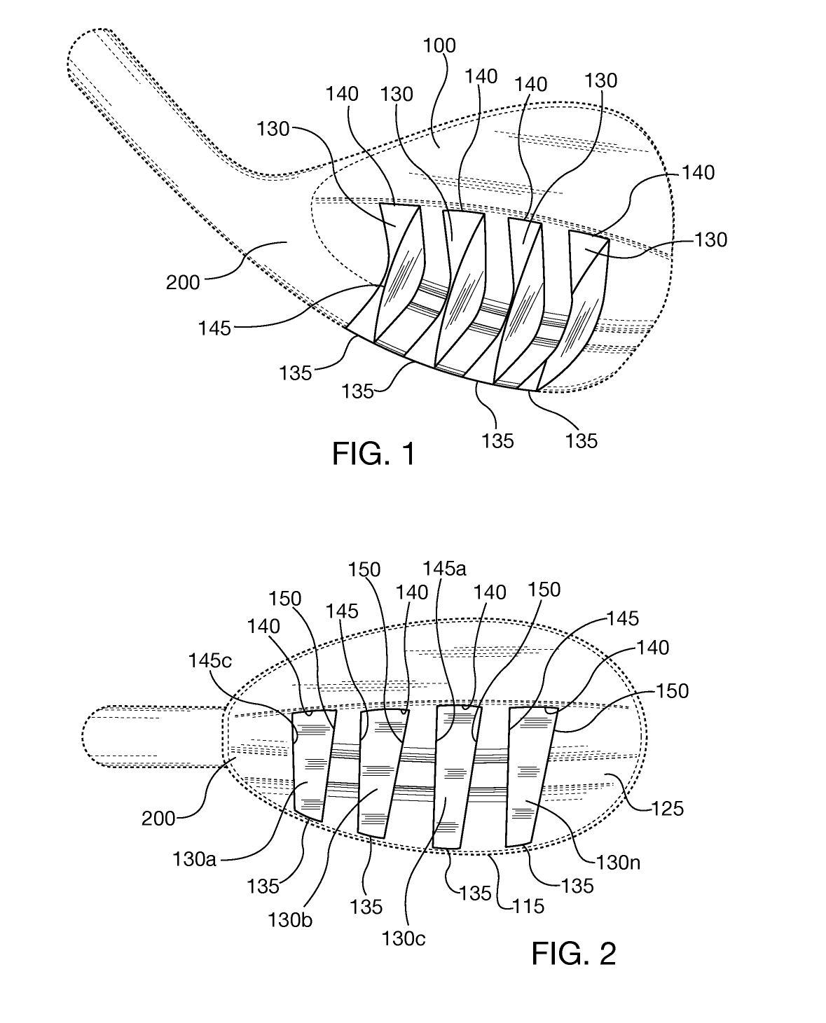

Referring now to the FIGS. wherein like numeral indicate like elements throughout, an illustrative golf club head 100 is shown. As shown in FIGS. 1-4, the golf club head 100 includes a face 110 adapted for striking a golf ball. The face 110 includes a leading edge 115. The face 110 may also include a plurality of grooves 120 adapted to provide spin on a golf ball.

The golf club head 100 also includes a sole 125 extending from the face leading edge 115. The sole 125 includes a plurality of channels 130a-130n (collectively 130). The channels 130 may be configured to permit the club head 100 to penetrate and pass through the ground whilst maintaining a substantial amount of club head speed prior to striking a golf ball.

In one embodiment, each channel 130 includes a first end 135 adjacent to the face leading edge 115. In one embodiment, the first end 135 is offset from the face leading edge 115. Each channel 130 also includes a second end 140 spaced from the first end 135. In one embodiment, the width of the first end 135 is smaller than the width of the second end 140. However, it will be appreciated that the first and second ends 135, 140 may have equal widths and remain within the scope of the present disclosure. Further, it will be appreciated that the first end width 135 may be greater than the second end 140 width.

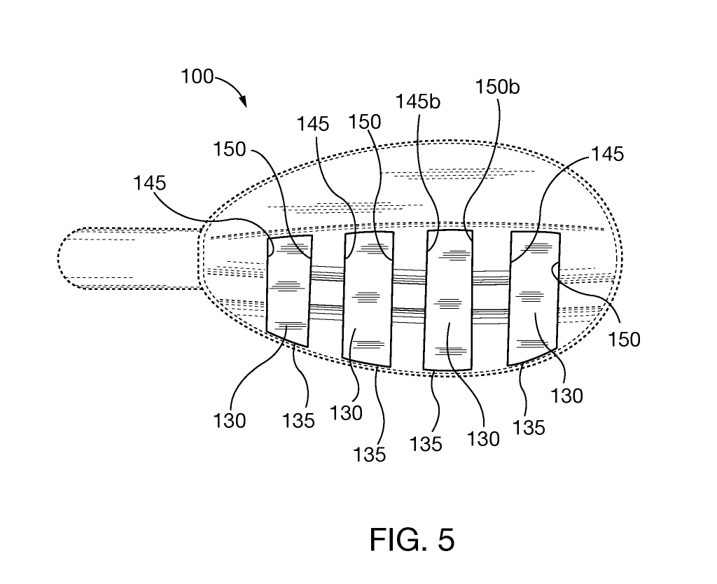

In one embodiment, each channel 130 includes a first sidewall 145 and a second sidewall 150 joined together by a base wall 152. In one embodiment, as shown in FIG. 2, at least one channel first side wall 145a of at least one channel 130c is substantially perpendicular to the face leading edge 115. In an alternative embodiment, as shown in FIG. 5, at least one channel first sidewall 145b of at least one channel 130c and at least one channel second side wall 150b of at least one channel 130c are substantially perpendicular to the face leading edge 115. However, it will be appreciated that each first sidewall 145 and each second sidewall 150 may have any suitable relationship relative to the face leading edge 115 and remain within the scope of the present disclosure. It will further be appreciated that the sidewalls 145, 150 of different channels 130 may have different relationships to the face leading edge 115 as compared to the sidewalls 145, 150 of other channels 130 in the same club head 100.

Referring again to FIGS. 1-4, in one embodiment, each first sidewall 145 of a given channel 130 is at an angle relative to the corresponding second sidewall 150 of the given channel 130. In one embodiment, the angle between the first sidewall 145 and second sidewall 150 is between 0 degrees and 45 degrees; however, it will be appreciated that the first and second sidewalls 145, 150 may be in any suitable relationship with one another and remain within the scope of the present disclosure. Further, it will be appreciated that the first sidewalls 145 may be parallel with one another. Similarly, it will be appreciated that the second sidewalls 150 may be parallel with one another. However, it will be appreciated that the first sidewalls may have any suitable relationship relative to one another and that the second sidewalls may have any suitable relationship relative to one another and remain within the scope of the present disclosure. In an alternative embodiment, as best shown in FIG. 5, the first and second sidewalls 145, 150 are parallel with one another.

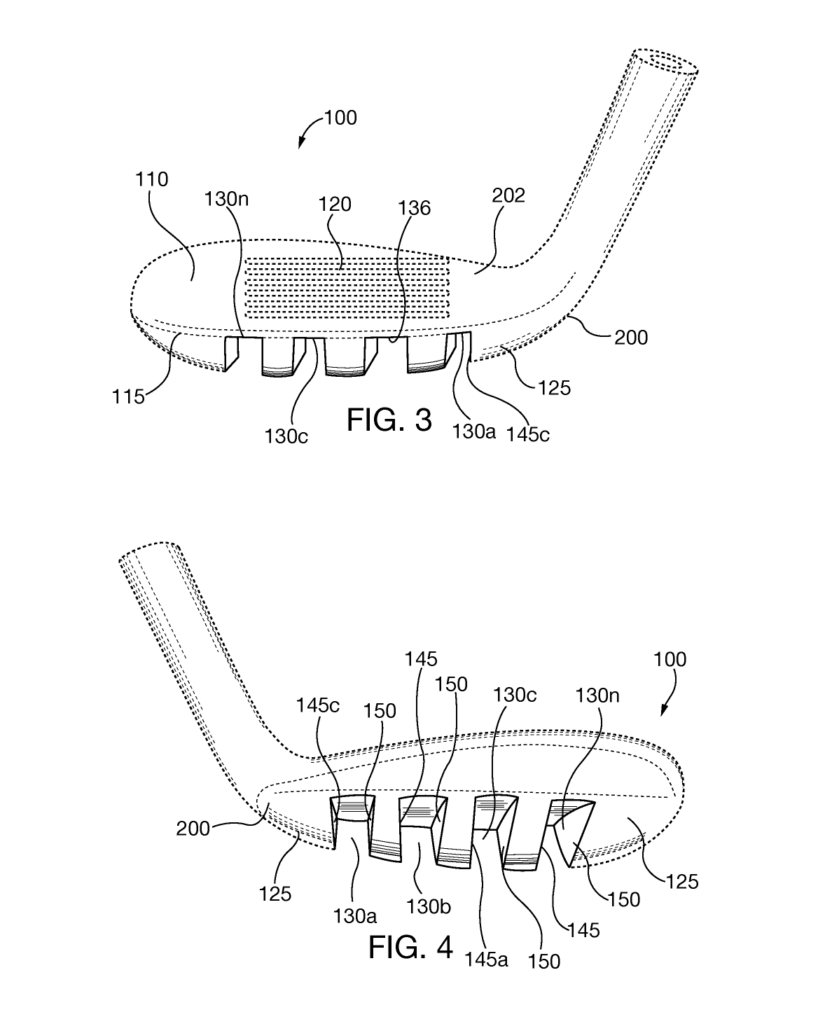

In one embodiment, as best shown in FIG. 3, the first sidewall 145c of the channel 130a nearest the heel 200 of the club head 100 may be formed to be substantially collinear with the ends 202 of the grooves 120 on the face 110. However, it will be appreciated that the channels 130 may be disposed about the sole 125 in any suitable arrangement and remain within the scope of the present disclosure. While the illustrative embodiments employ channels have a squared cross-section (i.e., with the sidewalls at right angles to the base wall), it will be appreciated that each channel may have any suitable cross-section and remain within the scope of the present disclosure. For example, and without limitation, each channel may have an arcuate cross-section, a triangular cross-section, or any other suitable cross-section. Additionally, while each channel is shown as having equal height along the length of the channel, it will be appreciated that the height of each channels may increase, decrease, or undulate along the length of the channel and remain within the scope of the present disclosure.

In use, the channels 130 may reduce the resistance the club head 100 encounters when swung towards the ball yet penetrates the ground (e.g., fairway, rough, sand, pan, weeds, dirt, etc.) prior to striking the ball. Therefore, the club face 110 may pass through the ground in a relatively quick fashion thereby allowing the face 110 to make a relatively clean and quick contact with the ball so as to provide maximum distance to the ball and control to the user. In an embodiment where the second sidewalls 150 are at an angle relative to the first sidewalls 145 (see, e.g., FIG. 2), the user of the club may selectively open the club head 100 for a flop and the channels 130 may then still permit the club head 100 to penetrate the ground as previously discussed. Furthermore, the relatively quick fashion the club head 100 passes through the ground prior to striking the ball may permit relatively amateur golfers to increase the backspin they are able to place on the ball.

A method for forming a golf club head 100 as discussed above is also disclosed. A golf club head 100 may be provided having a face, a leading edge and a sole. The golf club head may be formed from any suitable material, including, but not limited to, metal, polymer, composite or any other suitable material. The channels 130 may then be formed in the sole of the club head. While the illustrative embodiment shows four such channels, it will be appreciated that any number of channels may be formed in the club head and remain within the scope of the present disclosure. Moreover, while the illustrative embodiment shows a club head for a wedge having a bounce angle between approximately 12 degrees and 14 degrees, it will be appreciated that such channels may be formed in any suitable golf club head (driver, wood, iron, sand wedge, pitching wedge, etc.) and remain within the scope of the present disclosure. Furthermore, it will be appreciated that channels may be formed in the club head during an initial procedure, such as molding, or a secondary operation, such as machining, or in any other suitable manner.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A golf club head comprising:
a face for striking a golf ball, the face including a leading edge; and
a sole extending from the face leading edge, the sole including a channel, wherein the channel includes a first end adjacent to the leading face leading edge and a second end spaced from the first end.

2. The channel of claim 1 further comprising a first sidewall and a second sidewall, wherein at least one of the first sidewall and the second sidewall is substantially perpendicular to the face leading edge.

3. The channel of claim 1 further comprising a first sidewall and a second sidewall, wherein the channel first sidewall is substantially perpendicular to the face leading edge and wherein the channel second sidewall is substantially perpendicular to the face leading edge.

4. The golf club head of claim 1 wherein the channel first end has a first width and the channel second end has a second width, wherein the first width is smaller than the second width.

5. The channel of claim 1 further comprising a first sidewall and a second sidewall, wherein the first sidewall and second sidewall are at an angle relative to one another.

6. The golf club head of claim 5 wherein the angle is between 0 degrees and 45 degrees.

7. A golf club head comprising:
a face for striking a golf ball, the face including a leading edge; and
a sole extending from the face leading edge, the sole including a plurality of channels, wherein each channel includes a first end adjacent to the leading face leading edge, a second end spaced from the first end, a first sidewall and a second sidewall.

8. The golf club head of claim 7 wherein the first sidewalls of the channels are substantially parallel with one another.

9. The golf club head of claim 7 wherein the second sidewalls of the channels are substantially parallel with one another.

10. The golf club head of claim 7 wherein the first sidewalls of the channels are substantially parallel with the second sidewalls of the channels.

11. The golf club head of claim 7 wherein at least one of the first sidewalls of at least one channel and at least one of the second sidewalls of at least one channel are substantially perpendicular with the face leading edge.

12. The golf club head of claim 7 wherein each first sidewall of the channels are at an angle relative to a corresponding second sidewall of a channel.

13. The golf club head of claim 12 wherein the angle between each first sidewall and the corresponding second sidewall is between zero degrees and 45 degrees.

14. The golf club head of claim 7 wherein at least one channel first end has a first width and a corresponding channel second end has a second width, wherein the first width is smaller than the second width.

15. A method for constructing golf club head, comprising:
providing a golf club head including a face for striking a golf ball, the face including a leading edge; and a sole extending from the face leading edge; and
forming at least one channel in the sole, wherein each channel includes a first end adjacent to the leading face leading edge, a second end spaced from the first end, a first sidewall and a second sidewall.

16. The method of claim 15 wherein at least one of the channel first sidewall and channel second sidewall is substantially perpendicular to the face leading edge.

17. The method of claim 15 wherein the channel first sidewall is substantially perpendicular to the face leading edge and wherein the channel second sidewall is substantially perpendicular to the face leading edge.

18. The method of claim 15 wherein the channel first end has a first width and the channel second end has a second width, wherein the first width is smaller than the second width.

19. The method of claim 15 wherein the channel first sidewall and channel second sidewall are at an angle relative to one another.

20. The method of claim 19 wherein the angle is between 0 degrees and 45 degrees.
